(19) United States
(12) Patent Application Publication
(10) Pub. No.: US 2025/0206397 A1
(43) Pub. Date: Jun. 26, 2025

(54) Fender Protector

(71) Applicant: Jed Michael Yost, Montezuma, KS (US)

(72) Inventor: Jed Michael Yost, Montezuma, KS (US)

(21) Appl. No.: 18/987,340

(22) Filed: Dec. 19, 2024

Related U.S. Application Data
(60) Provisional application No. 63/612,885, filed on Dec. 20, 2023.

(51) Int. Cl. B62H 3/04; B60R 9/06; B60R 9/10

(52) U.S. Cl. CPC B62H 3/04; B60R 9/06; B60R 9/10

(57) ABSTRACT

Apparatus, system, and method for protecting a bicycle fender. The apparatus includes a body that includes a sidewall that at least partially defines a protected volume for slidably receiving the fender. The sidewall includes a lower sidewall sized to be received between the fender and a tire, and the sidewall includes an upper sidewall that receives a clamping force. The clamping force is transferred from the upper sidewall, around the fender, and to the tire via the lower sidewall.

### TECHNICAL FIELD

Novel aspects of the present disclosure relate to the field of vehicle accessories and more particularly to an apparatus for protecting bicycle fenders.

### BACKGROUND

Bicycle racks can be mounted to cars to facilitate the transport of bicycles. Bicycles can be secured, at least in part, to the bicycle rack by one or more adjustable arms or hoops, referred to herein as an adjustable hoop for the sake of simplicity, which traps one or both of the wheels to a rail that is mounted to the car. Some conventional bicycle racks include an adjustable hoop for securing the front wheel to the bicycle rack and an adjustable strap for securing the rear wheel to the bicycle rack.

### SUMMARY OF THE INVENTION

Novel aspects of the present disclosure are directed to an apparatus for protecting bicycle fenders suspended above a surface of a bicycle tire. The apparatus comprises a body that includes a sidewall that at least partially defines a protected volume for receiving the fender. At least a portion of the sidewall is sized to be received between the fender and the tire, and the sidewall provides a clamping force to the tire.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the disclosure are set forth in the appended claims. A preferred mode of use, further objectives and advantages thereof, will be best understood by reference to the following detailed description of illustrative embodiments when read in conjunction with the accompanying figures, wherein:

FIGS. 1-9 are various views of a fender protector according to an illustrative embodiment;

FIG. 10 is an image depicting the fender protector in an installed configuration; and

FIG. 11 is another image depicting the fender protector in the installed configuration.

### DETAILED DESCRIPTION

Bicycle fenders, also known as mud guards, can protect riders from water and rocks that might be thrown upward to the rider. A fender mounted above the front wheel can prevent the adjustable hoop of a bicycle rack from engaging the bicycle wheel. Instead, a clamping force of the adjustable hoop is applied to the front fender, which can deform the fender and prevent the bicycle from being securely mounted to the bicycle rack. Novel aspects of the present disclosure provide for a fender protector that can receive the clamping force of the adjustable hoop of the bicycle rack and transfer the clamping force to the tire. In some embodiments, the clamping force is received at a location above the bicycle fender and then transferred around the bicycle fender and to the tire.

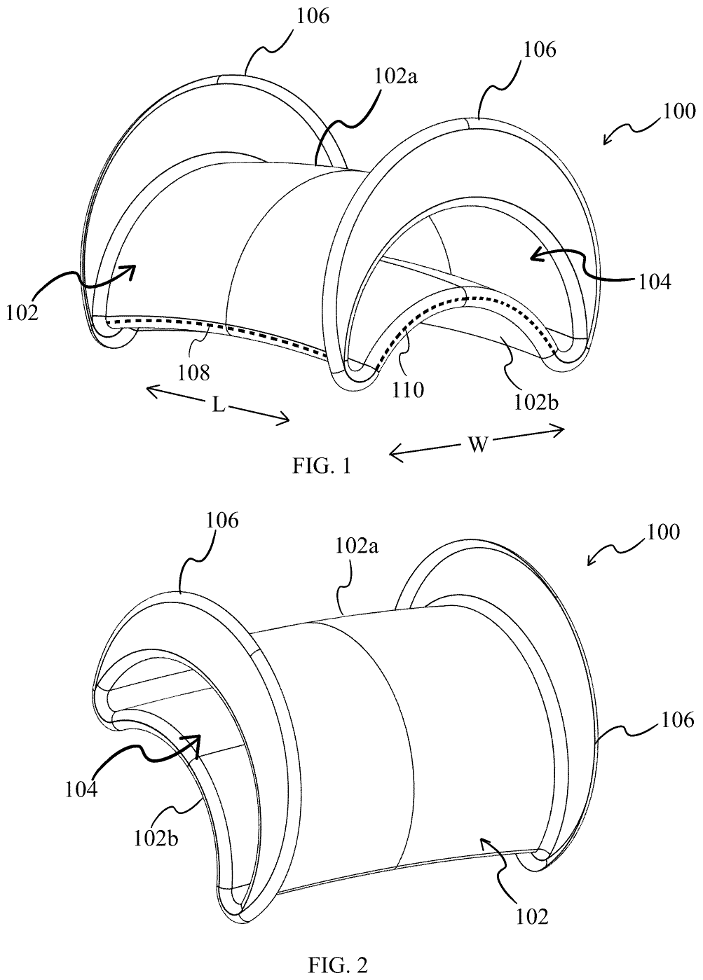

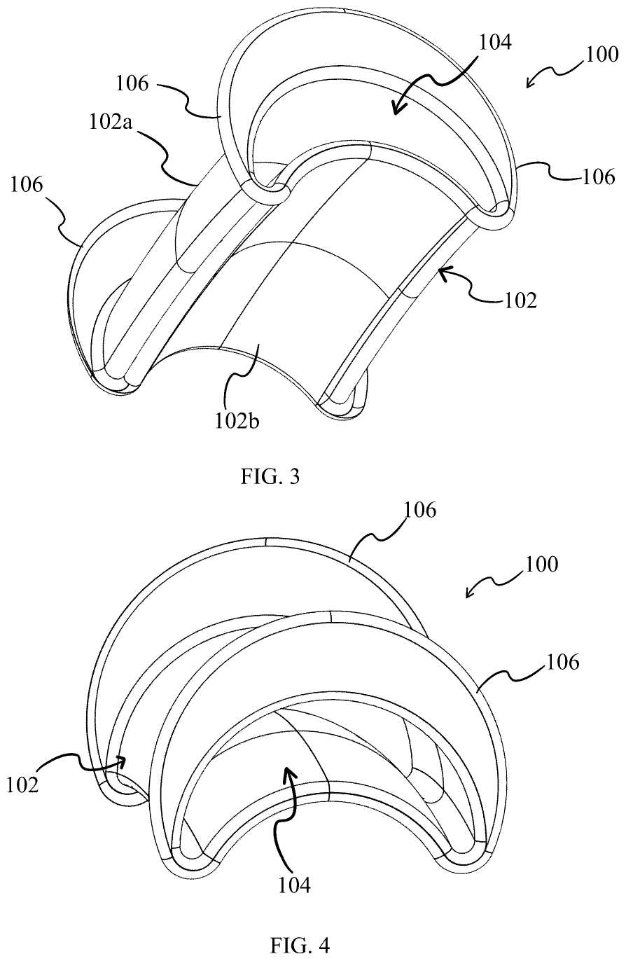

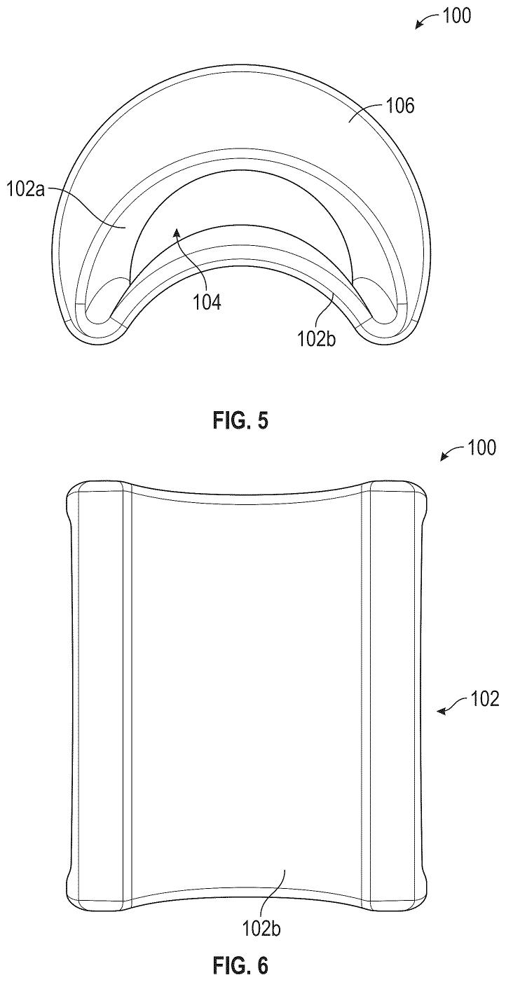

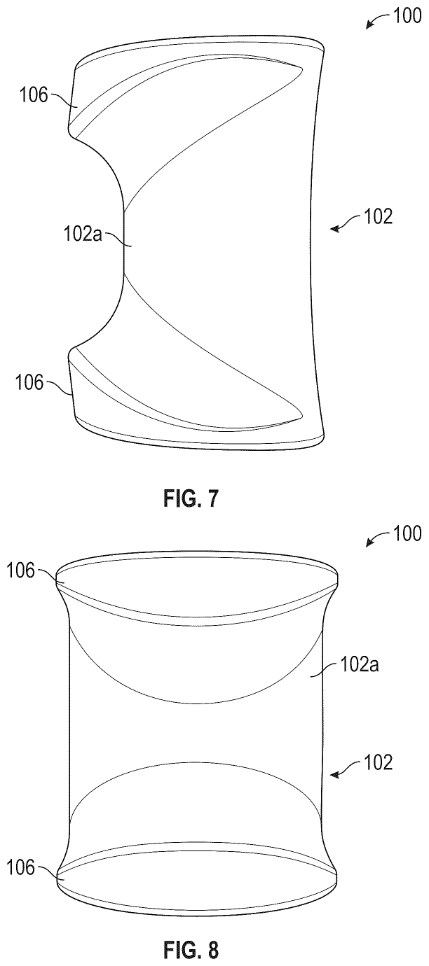

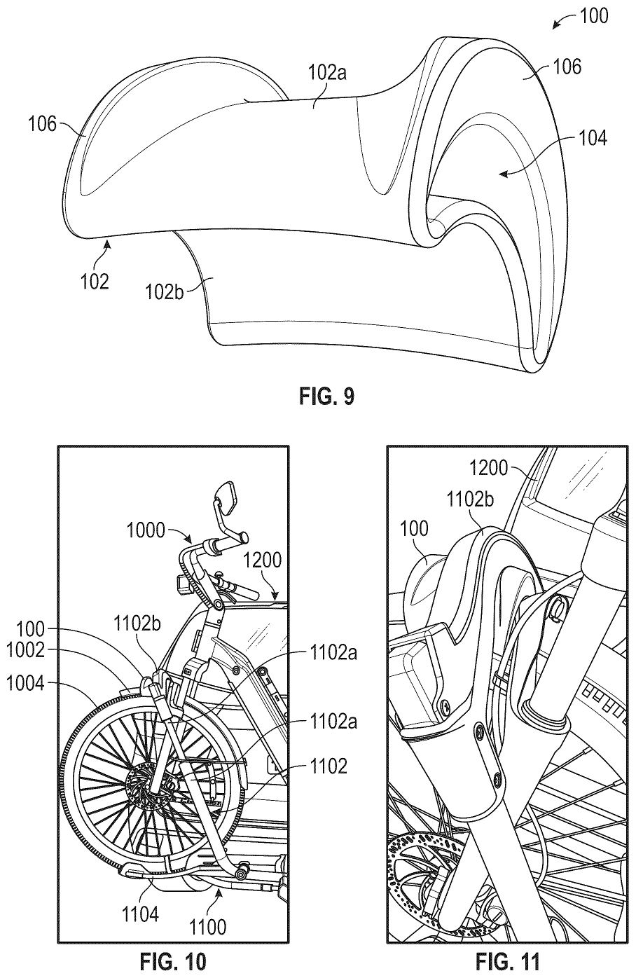

FIGS. 1-9 are various views of a fender protector according to an illustrative embodiment. Fender protector 100 is formed generally from a saddle-shaped body 102 that defines a passage 104 with a crescent-shaped cross-section. The passage 104 is shaped to receive a bicycle fender when installed, as shown in more detail in FIGS. 10 and 11 that follow. At opposing ends of the body 102 are flanges 106, which help to seat the adjustable hoop of a bicycle rack on the upper sidewall 102a of the body 102 and prevent unintended travel of the fender protector 100 after installation. Additionally, the flanges 106 can provide a securing force against a sturdy portion of the bicycle, such as the frame or fork (as can be seen in FIG. 10). The clamping force is transferred to the tire of the bicycle via the lower sidewall 102b of the body 102.

The fender protector 100 can be formed from a rigid material using conventional manufacturing means. For example, the fender protector 100 can be formed from a polymer, a metal or metallic alloy using printing, molding, casting, or forging techniques.

In the non-limiting embodiment shown in FIGS. 1-9, the body 102 has a length dimension L that is longer than its width dimension W. The body 102 also has a first curvature 108 along its length L and a second curvature 110 along its width W. The first curvature 108 is smaller than the second curvature 110. When installed, the length dimension L is oriented circumferentially around a portion of the bicycle tire and the width dimension W is oriented to generally span the width of the tire.

The fender protector 100 depicted in FIGS. 1-9 is shown as a unitary, standalone device that can slidably receive a fender of a bicycle during installation, and then receive a clamping force from the adjustable hoop from a conventional bicycle rack. The clamping force can then be transferred through the body 102 of the fender protector 100 to the tire of the bicycle. However, in another embodiment (not shown), the body 102 of the fender protector 100 can be a standalone device formed from two halves, e.g., an upper sidewall 102a wholly or partially separable from the lower sidewall 102b, that can be removably coupled together using conventional fastening means. Installation can be achieved by situating the lower sidewall 102b between the tire and fender, then attaching the upper sidewall 102a, or attaching the two sidewalls 102a and 102b and installing the fender protector 100 as previously described.

In yet another embodiment (not shown), the fender protector 100 can be fixed to (i.e., removably attached to or integrally formed with) the adjustable hoop of a bicycle rack. In a first version of this other embodiment, the fender protector 100 is a unitary structure that is fixed to the adjustable hoop and installed by simply rotating the adjustable hoop in an arcuate path that causes the fender to be received by the passage 104 of the fender protector 100. In a second version of this embodiment, the fender protector 100 can be partially fixed to the adjustable hoop of a bicycle rack. For example, if the upper sidewall 102a is fixed to the adjustable hoop, then installation can involve proper placement of the lower sidewall 102b between the tire and the fender, then clamping of adjustable hoop to cause the upper sidewall 102a to engage the lower sidewall 102b, transferring the clamping force through the body 102 of the fender protector 100 and around the fender. In these embodiments, the fender protector 100 can be rotatably attached to the adjustable hoop, e.g., with the axis of rotation generally parallel to the width dimension W of the fender protector 100, to facilitate installation.

FIGS. 10 and 11 are images depicting the fender protector in an installed configuration. The bicycle 1000 is mounted to a car 1200 by a rack 1100. The rack 1100 includes an adjustable hoop 1102, which is formed from an arm 1102a and a curved endpiece 1102b. The curved endpiece 1102b is adjustable relative to the arm 1102a to provide the clamping force that secures the bicycle 1000 to the rack 1100. The adjustable hoop 1102 is rotatably coupled to a rail 1104.

In the installed configuration, the fender 1002 of the bicycle 1000 is received in the passage 104 of the fender protector 100. The lower sidewall 102b is in contact with the tire 1004 and the upper sidewall 102a is in contact with the curved endpiece 1102b. The clamping force provided by the adjustable hoop 1102 secures the tire 1004 to the rail 1104, which is in turn mounted to the car 1200. One of the flanges 106 of the fender protector 100 is secured against the arch 1006 of the front suspension fork 1108.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An apparatus for protecting a fender of a bicycle, the fender suspended above a surface of a tire, the apparatus comprising:
a body that includes a sidewall that at least partially defines a protected volume for slidably receiving the fender, and wherein:
the sidewall includes a lower sidewall sized to be received between the fender and the tire,
the sidewall includes an upper sidewall configured to receive a clamping force, and
the clamping force is transferred from the upper sidewall, around the fender and to the tire via the lower sidewall.

2. The apparatus of claim 1, wherein the protected volume is a passage with a crescent-shaped cross section.

3. The apparatus of claim 1, wherein the body is generally saddle-shaped.

4. The apparatus of claim 1, wherein the body includes a flange at opposing ends.

5. The apparatus of claim 1, wherein the sidewall includes a first curvature along a length dimension and a second curvature along a width dimension, the second curvature being greater than the first curvature.

6. The apparatus of claim 1, wherein the apparatus is fixed to an adjustable arm of a bicycle rack.

7. A method of protecting a fender of a bicycle, the fender suspended above a surface of a tire, the method comprising:
aligning an aperture of an apparatus with the fender, wherein the apparatus includes a body that includes a sidewall formed from an upper sidewall and a lower sidewall, wherein the sidewall at least partially defines a protected volume for slidably receiving the fender;
sliding the apparatus along a length of the fender;
positioning the lower sidewall against the tire; and
lowering an adjustable hoop onto the upper sidewall to provide a clamping force that is transferred from the upper sidewall, around the fender and to the tire via the lower sidewall.

8. A bicycle rack comprising:
an adjustable hoop; and
an apparatus fixed to the adjustable hoop, wherein the apparatus comprises a body that includes a sidewall that at least partially defines a protected volume for slidably receiving the fender, and wherein:
the sidewall includes a lower sidewall sized to be received between the fender and the tire, and
the sidewall includes an upper sidewall configured to receive a clamping force, and the clamping force is transferred from the upper sidewall, around the fender, and to the tire via the lower sidewall.

9. The bicycle rack of claim 8, wherein the protected volume is a passage with a crescent-shaped cross section.

10. The bicycle rack of claim 8, wherein the body is generally saddle-shaped.

11. The bicycle rack of claim 8, wherein the body includes a flange at opposing ends.

12. The bicycle rack of claim 8, wherein the sidewall includes a first curvature along a length dimension and a second curvature along a width dimension, the second curvature being greater than the first curvature.
